(19) United States
(12) Patent Application Publication
(10) Pub. No.: US 2004/0245243 A1
(43) Pub. Date: Dec. 9, 2004

(54) APPARATUS FOR WARMING GYNECOLOGICAL INSTRUMENTS

(76) Inventor: Lino A. Ossanna, Medina, NY (US)

Correspondence Address: SIMPSON & SIMPSON, PLLC, 5555 MAIN STREET, WILLIAMSVILLE, NY, 14221-5406, US

(21) Appl. No.: 10/250,134

(22) Filed: Jun. 5, 2003

(51) Int. Cl. H05B 3/06

(52) U.S. Cl. 219/521; 219/386

(57) ABSTRACT

An apparatus for warming a medical instrument, preferably a speculum, generally includes a sleeve insert for securing the medical instrument therein, a heating element operatively arranged to heat the sleeve insert and a thermostat operatively arranged to control the temperature of the heating element at or near approximate human body temperature.

### FIELD OF THE INVENTION

The present invention relates generally to an apparatus for warming medical instruments, and more particularly, to an apparatus for warming gynecological instruments to approximate body temperature and maintaining the temperature thereof.

### BACKGROUND OF THE INVENTION

An important part of any woman's health care regimen includes monitoring and maintaining one's reproductive health. Indeed, a host of reproductive diseases and bacterial and viral infections detrimentally affect a large number of women each year. For example, in 2002 the Centers for Disease Control estimated that nearly 13,000 U.S. women would be diagnosed with cervical cancer and that approximately 4,100 women would die from the disease that year. In addition, a large number of women are often infected with sexually transmitted diseases such as syphilis, gonorrhea, chlamydia and the like. An even larger number of women contract more common infections such as bacterial vaginosis. These types of viral and bacteriological infections can have adverse effects upon a woman's reproductive health and affect the health of their offspring. Consequently, because such a large number of women can be affected by such a large number of reproductive ailments, most health care professionals and practitioners recommend that all women over the age of eighteen and all sexually active women undergo regular gynecological examinations. Indeed, annual gynecological examinations are a considered to be an essential component of any woman's health care practices.

While most women regard routine gynecological examinations as an important part of their health care regimen, most would probably also regard the gynecological examination as an intrusive, uncomfortable, and “cold” procedure. Indeed, to perform such examinations, women are typically placed into what are often regarded as “compromising” positions, both mentally and physically, and are examined by means of unforgiving and menacing instruments. The most common instrument used in such procedures is the speculum, which is used to hold the vaginal walls apart to facilitate a clear view of the vagina and the cervix.

Many types of speculum are known in the art and most vary according to size, shape and appearance. Additionally, the type of speculum can vary according to the particular procedure that is to be performed. However, while many different types of speculum are known, most share one common characteristic; they are often made from surgical grade steel or metals that are good thermal conductors such that they are perceived as being extremely “cold” to the touch. Thus, in addition to being mentally and physically invasive, the gynecological exam can also be unpleasant and “cold” to the touch.

In view of this lack of comfort, many gynecologists and health care practitioners attempt to make the gynecological examination as pleasant as possible. For example, in order to create comfortable surroundings some practitioners may decorate their offices in “warm” colors, play soothing music, utilize aroma therapies, or allow their patients to watch television in order to instill a sense of relaxation. Moreover, in order to make the gynecological examination tactilely comfortable, e.g. comfortable to the touch, many practitioners warm the cold medical instruments prior to their being used. This is typically performed by placing the instruments upon a heating pad, in a heated drawer, or by warming the instruments using warm water. While such methods are generally effective to warm the instruments, they are often perceived as archaic, unprofessional, unsanitary and are not particularly sterile. Additionally, warming of the instruments utilizing such methods often results in instruments that are too hot or too cold to the touch.

What is needed, then, is a professionally appearing apparatus for warming and storing gynecological instruments such that the instruments are readily accessible to the health care practitioner and are sanitarily maintained at a desirable temperature near that of a patient's body temperature.

### SUMMARY OF THE INVENTION

The present invention broadly comprises an apparatus for storing a gynecological medical instrument, e.g. a speculum, at a relatively constant temperature. The apparatus generally comprises means for releasably securing one or more medical instruments therein, means for warming the instruments and means for maintaining the temperature of the instruments at a constant desired temperature.

Thus, a primary object of the present invention is to provide a means for storing a gynecological instrument, or other similar instrument, such that the instrument is readily accessible to the user.

Another object of the present invention is to provide a means for storing a gynecological instrument, or other similar instrument, at a constant desired temperature.

A final object of the present invention is to provide a readily accessible means for sanitarily and/or sterilely storing a gynecological instrument at a constant approximate body temperature.

These and other objects, features and advantages of the invention will become apparent upon reading the following detailed description and the appended drawings and claims.

### BRIEF DESCRIPTION OF THE DRAWINGS

The nature and mode of operation of the present invention will now be more fully described in the following detailed description of the invention read together with the accompanying drawing figures, in which:

FIG. 1 is an illustration of a preferred embodiment of the present invention, which shows a pair of sleeve inserts for securing a gynecological device therein;

FIG. 2 is an illustration of a preferred embodiment of the present invention, which shows a pair of sleeve removed from the housing of the present invention; and,

FIG. 3 is an illustration of a preferred embodiment of the present invention, which shows the internal structures of the present invention for maintaining sleeve inserts at a constant approximate body temperature.

### DETAILED DESCRIPTION OF A PREFERRED EMBODIMENT

It should be appreciated at the outset that, in the detailed description that follows, like reference numbers on different drawing views are intended to identify identical structural elements of the invention in the respective views. It should also be appreciated that, for purposes of the present description and claims, the terms “substantial”, “approximate” and like terms or phrases, as they may be used to refer to the temperatures of components of the present invention, are intended to connotate temperatures between +/−10 Â° Fahrenheit of a desired temperature. For example, where the present invention is adapted to maintain a sleeve insert at an “approximate body temperature”, the temperature of the sleeve insert may range between 88.6 Â° and 108.6 Â° Fahrenheit, where body temperature is 98.6 Â° Fahrenheit. It should be further appreciated that, while in a preferred embodiment, the present invention is configured for maintaining a sleeve insert at an approximate body temperature, the present invention may be configured to maintain a sleeve insert at any desired temperature.

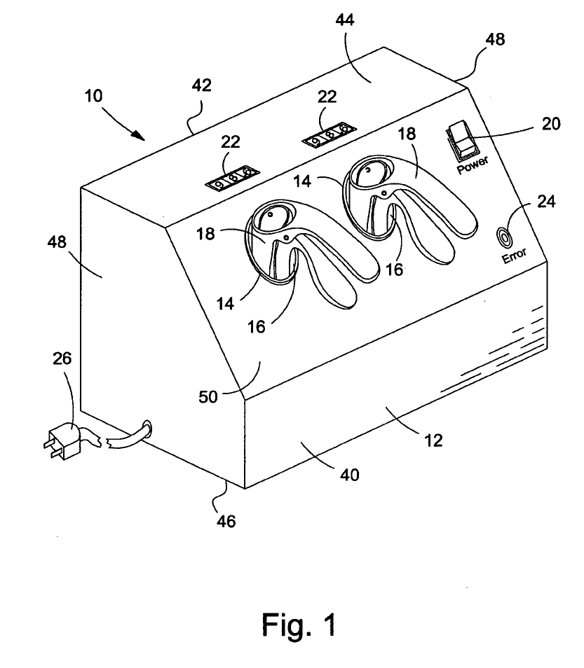

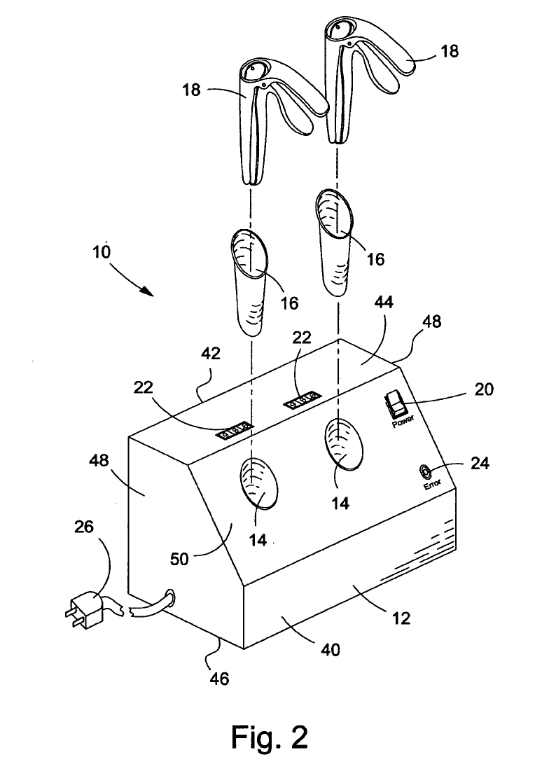

Adverting now to the Figures; as shown in FIGS. 1 and 2, the outer structure of medical instrument warming apparatus 10 broadly comprises housing 12, sleeve inserts 16 adapted for substantial physical contact within sleeve holders 14 (e.g. nesting fit), standard electrical cord and plug 26 for providing electrical power, power on/off switch 20, error indicator means 24, and temperature indicator means 22.

More specifically, housing 10 may be adapted to comprise a substantially rectangular-shaped box having front 40, back 42, top 44, bottom 46, sides 48 and angled side 50. Disposed within angled side 50 may be at least one through-bore for accepting and securing sleeve holder 14 and sleeve insert 16 therein. It should be appreciated by those having ordinary skill in the art that while FIGS. 1-3 illustrate sleeve holder(s) 14 and sleeve insert(s) disposed within housing 12 at an angle substantially perpendicular to the planar surface of top 42 and bottom 46, the sleeve holders and the sleeve inserts could be disposed within the housing at an angle perpendicular to the planar surface of angled side 50. Angled side 50 may be further adapted to comprise power on/off switch 20, for switching the electric power of the apparatus on and off. Angled side 50 may also be configured to comprise error indicator light 24, for visually indicating an apparatus malfunction; for example, excessive heating. It should be appreciated by those having ordinary skill in the art that power on/off switch 20 may comprise an indicator type switch capable of being illuminated in order to indicate that the power of the apparatus is on. Finally, it should be readily appreciated by those having ordinary skill in the art that the housing of the present invention is not limited to a rectangular box-shape; indeed, other aesthetically appealing or practical housing shapes and configurations are contemplated and are intended to be encompassed by the present disclosure. Also, it should be appreciated that various components of the present invention could be arranged at any desired location; for example, error indicator light 24, power on/off switch 20, or other component could be located on top 44.

Sleeve inserts 16 are operatively arranged for substantial physical contact with sleeve holders 14 such that heat emanating from the sleeve holders is efficiently transferred to the sleeve inserts. For example, sleeve holders 14 and sleeve inserts 16 may be adapted for nesting fit with one another. It should be appreciated by those having ordinary skill in the art that while sleeve inserts 16 and sleeve holders 14 are shown as being substantially cylindrical in shape to correspond to the shape of a gynecological instrument (e.g. specula 18), sleeve inserts 16 and sleeve holders 18 may comprise any desired shape. Indeed, sleeve inserts 16 and sleeve holders 14 may be adapted for accepting other medical instruments and/or adapted for accepting specula 18 comprising alternative shapes or specula that may comprise over-wrapping for maintaining the sterility of the instruments, as is typically the case in an examination setting.

Error indicator means 24 of the present invention generally comprises an illumination means for visually indicating an apparatus failure; for example, if the temperature of the sleeve holders and sleeve inserts too high, is not at or near approximate body temperature, or if the apparatus is malfunctioning. In a preferred embodiment, error indictor means 24 comprises an illumination means operatively arranged to flash when an error has occurred. Error indicator means 24 may be adapted to comprise a conventional light bulb, a light emitting diode (LED), or other known illumination device.

Temperature indicator means 22 are provided for indicating whether sleeve holders 14 and sleeve inserts 16 are maintained at the proper desired temperatures. For example, where the power to apparatus has only recently been turned on, sleeve holders 14 and sleeve inserts 16 will need time to warm up to the desired temperature and temperature indicator means 22 may be used to determine whether the desired temperature has been reached. Temperature indicator means may comprise simple illumination means, such as a light operatively arranged to be turned on or off by a control device once a desired temperature is reached, or may comprise a visual display device, such as an LCD adapted to illustrate the actual real time temperature of the sleeve holders 14 and sleeve inserts 16. In a preferred embodiment, a separate temperature indicator means 22 are provided for each sleeve holder 14 and/or sleeve insert 16.

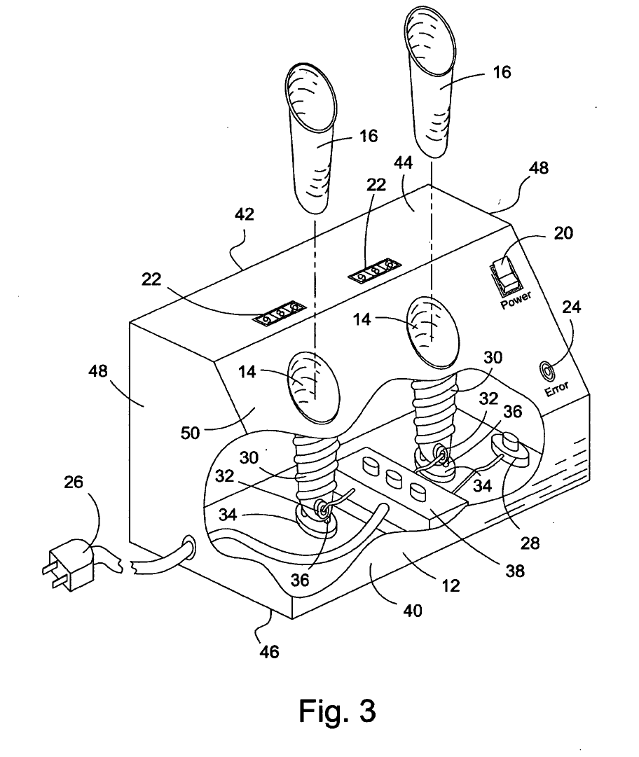

As shown in FIG. 3, the internal structures of the present invention generally comprise audible error indicator 28, heating element(s) 30, temperature sensor(s) 32, insulator 34, offset(s) 36, and thermostat 38.

The present invention comprises at least one thermostat 38 for controlling and maintaining the temperature of heating element(s) 30. The thermostat is of a type well known in the art, such as that which may be used in an electric iron or other similar electrical heating appliance. In a preferred embodiment, the thermostat of the present invention is non-adjustable for maintaining the temperature of the sleeve holder at an approximate human body temperature (98.6 Â° Fahrenheit). However, it should be appreciated that an adjustable thermostat may be substituted for purposes of varying the temperatures at which the sleeve holders and the sleeve inserts are maintained.

As can be appreciated, heating element(s) 30 are generally configured for heating sleeve holders 14 to approximate body temperature. Hence, in a preferred embodiment, heating element(s) 30 comprise electrically powered heating coils of a type well known in the art that are operatively arranged to simultaneously heat a large surface area of the sleeve holders. For this reason, FIG. 3 illustrates heating coils 30 as being wrapped about the outer surface of sleeve holders 14. It should be appreciated, however that other means of heating sleeve holders 14 are contemplated; for example, the present invention may be configured to comprise Peltier elements for heating sleeve holders 14, or may be adapted to comprise radiant heating means for heating sleeve holders 14; for example flow tubes for passing a heated medium therethrough may be wrapped about sleeve holders 14 or heating elements may be placed near the sleeve holders 14 such that heat emanating therefrom is absorbed. Finally, it should be appreciated by those having ordinary skill in the art that heating elements 30 may be configured to simultaneously support and directly heat sleeve inserts 16 such that sleeve holders are not required.

The invention further comprises temperature sensor(s) 32 for monitoring the temperature of the sleeve holder(s) 14 and sleeve insert(s) 16. Hence, FIG. 3 illustrates temperature sensor(s) 32 secured to sleeve holder(s) 14. It should be appreciated, however, that temperature sensor(s) 32 may be secured directly to heating element(s) 30 as an alternative method for monitoring the temperature of sleeve holder(s) 14 and sleeve insert(s) 16. Temperature sensor(s) 32 are operatively arranged for communication with thermostat 38 such that the thermostat may be turned on or off when the temperature sensors detect that the temperature of the heating element(s) 30, sleeve holder(s) 14 or sleeve insert(s) has fluctuated from a desired temperature. Additionally, sensor(s) 32 may also be configured for communication with temperature indicator means 22 and visual and audible error indicator means 24 and 28, respectively, for purposes of warning of apparatus malfunction or temperature deviation.

Finally, FIG. 3 also illustrates that heating element(s) 30 and sleeve holder (s) 16 may be operatively arranged above bottom 46 of the housing by offsets 36 and may be separated therefrom by insulator 34 for purposes of minimizing any threats that may be caused by heat emanating from heating coil(s) 30, such as fire or other damage.

Operation of the apparatus of the present invention is fairly simple. One need merely insert the plug into a standard outlet, insert any desired medical instruments into the sleeve inserts, turn the power on, and wait for the device to warm the instruments to the desired temperature.

Thus, it is seen that the objects of the present invention are efficiently obtained, although it should be readily apparent to those having ordinary skill in the art that changes and modifications can be made to the invention without departing from the spirit and scope of the invention as claimed.

Parts List

10 Medical Instrument Warming Apparatus

12 Housing

14 Sleeve Holder

16 Sleeve Insert

18 Medical Instrument

20 Power On/Off Switch

22 Temperature Indicator Means

24 Visual Error Indicator Means

26 Plug and Power Cord

28 Audible Error Indicator Means

30 Heating Element

32 Temperature Sensor

34 Insulator

36 Offset

38 Thermostat

40 Front

42 Back

44 Top

46 Bottom

48 Sides

50 Angled Side

1. An apparatus for warming a medical instrument comprising:
at least one sleeve insert for releasably securing said medical instrument therein, said sleeve insert complementarily shaped to correspond to the shape of said medical instrument and accept said medical instrument therein such that said medical instrument maintains contact with said sleeve insert;
a heating element operatively arranged to heat said sleeve insert; and,
a thermostat operatively arranged to control and maintain the temperature of said heating element and said medical instrument at a constant approximate body temperature.

2. The apparatus of claim 1 further comprising a housing for securing said sleeve insert.

3. The apparatus of claim 2 wherein said sleeve insert is releasably secured to said housing.

4. The apparatus of claim 1 further comprising a sleeve holder wherein said sleeve holder is operatively arranged to accept said sleeve insert therein and maintain substantial physical contact therewith; said heating element operatively arranged to heat said sleeve holder and said sleeve insert.

5. The apparatus of claim 1 wherein said heating element comprises a resistive heating element.

6. The apparatus of claim 1 wherein said thermostat is adjustable.

7. The apparatus of claim 1 wherein said thermostat is non-adjustable and adapted to maintain a constant approximate sleeve insert temperature.

8. (Canceled)

9. The apparatus of claim 1 wherein said sleeve insert is adapted to secure a speculum.

10. The apparatus of claim 1 further comprising a temperature sensor for monitoring the temperature of said sleeve insert.

11. The apparatus of claim 1 further comprising indicator means for indicating improper operation of said apparatus; said indicator means selected from the group consisting of audible and visual error indicator means.

12. An apparatus for warming a speculum comprising:
at least one sleeve insert operatively arranged for releasably securing said speculum therein, said sleeve insert corresponding to a shape of said speculum;
a heating element operatively arranged to heat said sleeve insert;
a thermostat operatively arranged to maintain said sleeve insert at a constant temperature; and,
a sensor operatively arranged to monitor the temperature of said sleeve insert.

13. An apparatus for warming a speculum comprising:
a housing for securing at least one sleeve insert therein
a sleeve insert secured to said housing and adapted to releasable secure said speculum therein;
a heating element operatively arranged to heat said sleeve insert, and,
a thermostat operatively arranged to maintain said sleeve insert at a constant approximate body temperature.

14. The apparatus of claim 14 comprising at least two sleeve inserts and said thermostat is operatively arranged to control the temperature of said at least two sleeve inserts.

15. The apparatus of claim 14 further comprising a sensor for monitoring the temperature of said sleeve insert.

16. The apparatus of claim 15 further comprising indicator means for indicating improper operation of said apparatus; said indicator means selected from the group consisting of audible and visual means.

17. The apparatus of claim 1 comprising more than one sleeve insert.

18. The apparatus of claim 12 comprising more than one sleeve insert.

19. The apparatus of claim 13 comprising more than one sleeve insert.

20. The apparatus of claim 1 wherein said medical instrument comprises a gynecological medical instrument configured for insertion into the human body and said sleeve insert is shaped for accepting said gynecological medical instrument therein such that said gynecological medical instrument maintains substantial complementary contact with the walls of said sleeve insert when said instrument is inserted therein.
